(19) United States
(12) Patent Application Publication
(10) Pub. No.: US 2009/0103194 A1
(43) Pub. Date: Apr. 23, 2009

(54) CAMERA MODULE WITH AUTOFOCUS FUNCTION AND AUTOFOCUS METHOD THEREOF

(75) Inventor: Ga-Lane Chen, Santa Clara, CA (US)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Taipei Hsien (TW)

(21) Appl. No.: 12/176,247

(22) Filed: Jul. 18, 2008

(30) Foreign Application Priority Data
Oct. 23, 2007 (CN) 200710202214.7

(51) Int. Cl. G03B 13/36; G02B 7/02

(52) U.S. Cl. 359/823; 396/127

(57) ABSTRACT

A camera module with an autofocus function includes a lens holder, a lens barrel, a light-sensing element, an actuator, and a controller. The lens barrel is coupled to the lens holder and has a number of optical elements received therein. The light-sensing element is accommodated in the lens holder and optically aligned with the optical elements of the lens barrel. The actuator includes a substrate and a shape-memory alloy film formed on the substrate. The substrate is substantially perpendicular to an optical axis of the camera module and interconnects the lens barrel and the lens holder. The controller is configured for applying an electric current to the shape-memory alloy film to bend the shape-memory alloy film, thereby allowing the lens module to move along the optical axis of the camera module.

### BACKGROUND

1. Technical Field

The invention relates to camera modules and, particularly, to a camera module with an autofocus function and autofocus method thereof.

2. Description of Related Art

Camera modules are widely used in various image capturing devices such as digital cameras and mobile phones. Such a camera module typically includes a lens module, an image sensor, and a motor. The motor is configured for driving the lens module to move and focus, thereby achieving a clear image on the image sensor. The motor is typically bulky, which is not beneficial for reduction in size of the camera module. Therefore, methods have been proposed such as, for example, a small voice coil magnet (VCM) actuator or liquid lens employed to focus the lens module. However, the response speed of the lens module adapted to the VCM actuator or the liquid lens by a driving signal (an electric signal) is low.

Therefore, it is desirable to provide a camera module with an autofocus function and autofocus method thereof, which can overcome the limitations discussed.

### SUMMARY

A camera module with an autofocus function includes a lens holder, a lens barrel, a light-sensing element, an actuator, and a controller. The lens barrel is coupled to the lens holder and has a number of optical elements received therein. The light-sensing element is accommodated in the lens holder and optically aligned with the optical elements of the lens barrel. The actuator includes a substrate and a shape-memory alloy film formed on the substrate. The substrate is substantially perpendicular to an optical axis of the camera module and interconnects the lens barrel and the lens holder. The controller is configured for applying an electric current to the shape-memory alloy film to re-shape the shape-memory alloy film, thereby moving the lens module along the optical axis of the camera module.

### BRIEF DESCRIPTION OF THE DRAWINGS

Many aspects of the present camera module with an autofocus function and autofocus method should be better understood with reference to the following drawings. The components in the drawings are not necessarily drawn to scale, the emphasis instead being placed upon clearly illustrating the principles of the present camera module and autofocus method thereof. Moreover, in the drawings, like reference numerals designate corresponding parts throughout the several views.

FIG. 1 is a schematic cross-section of a camera module, according to a first exemplary embodiment.

FIG. 2 is a block diagram showing employment of an autofocus function of the camera module of FIG. 1.

FIG. 3 is a flowchart of an autofocus method, according to a second exemplary embodiment.

FIG. 4 is a schematic cross-section of a camera module, according to a third exemplary embodiment.

FIG. 5 is a block diagram showing employment of an autofocus function of the camera module of FIG. 4.

FIG. 6 is a flowchart of an autofocus method, according to a fourth exemplary embodiment.

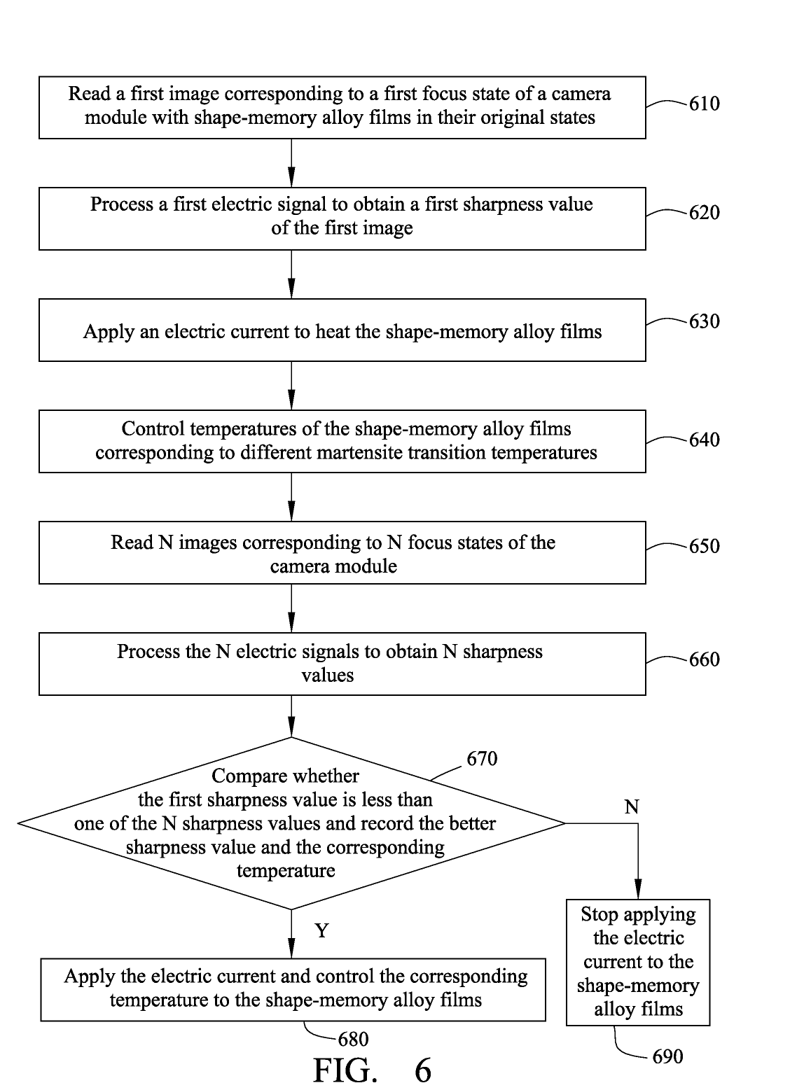

### DETAILED DESCRIPTION OF THE EMBODIMENTS

Embodiments of the present camera module with an autofocus function and autofocus method will now be described in detail with reference to the drawings.

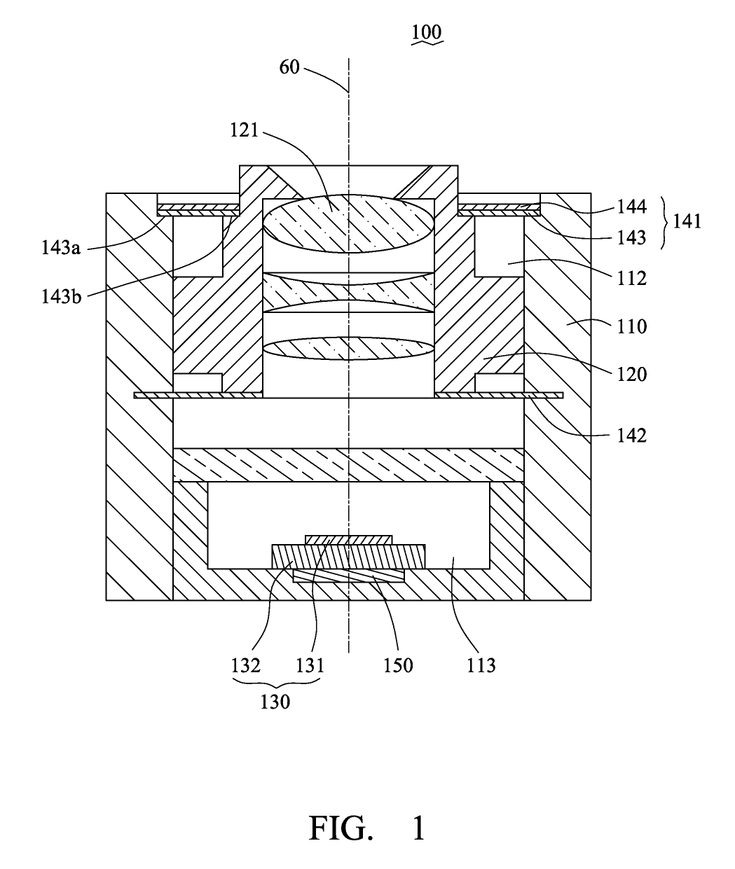

Referring to FIG. 1, a camera module 100 with an autofocus function includes a lens holder 110, a lens barrel 120, and a light-sensing unit 130. The lens holder 110 includes a top chamber 112 and a bottom chamber 113 communicating with the top chamber 112. The lens barrel 120 is received in the top chamber 112. The light-sensing unit 130 is accommodated within the bottom chamber 113. The lens barrel 120 includes a number of optical elements such as lenses 121 received therein. The light-sensing unit 130 is optically aligned with the optical elements of the lens barrel 120, thereby defining an optical axis 60 of the camera module 100.

The lens barrel 120 is fitted into the top chamber 112, thus ensuring that the lens barrel 120 is capable of sliding in the top chamber without deviating from the optical axis 60 of the camera module 100.

The light-sensing unit 130 includes a light-sensing element 131 and an image signal processing (ISP) unit 132. The light-sensing element 131 may be a charge-coupled device (CCD) or a complementary Metal-Oxide-Semiconductor (CMOS) image sensor. In this embodiment, the light-sensing element 131 and the ISP unit 132 are integrated. The light-sensing unit 130 may be a Ceramic Leaded Chip Carrier (CLCC) semiconductor package, a Plastic Leaded Chip Carrier (PLCC) semiconductor package, or a chip scale package (CSP).

The camera module 100 also includes an actuator 141 and a controller 150. The actuator 141 includes a substrate 143, and a shape-memory alloy film (SMAF) 144. The SMAF 144 is formed, for example, coated, on a surface of the substrate 143. The lens barrel 120 forms a first step on the outer wall thereof. The lens holder 110 forms a second step on the inner wall thereof corresponding to the first step. The substrate 143 has two distal ends 143a, 143b respectively attached to the first step and the second step. Being so structured, the substrate 143 is substantially perpendicular to the optical axis 60 of the camera module 100.

The controller 150 is configured for applying an electric current to the SMAF 144 to heat the SMAF 144. When temperature of the heated SMAF 144 exceeds the martensite transition temperature, the SMAF 144 transitions structure from martensite phase into austensite phase, presented here as a flexible bend therein. Internal stress is induced between the SMAF 144 and the substrate 143. Therefore, the substrate 143 is bent corresponding to the flexible bend of the SMAF 144. The actuator 141 is bent, thereby allowing the lens barrel 120 to move along the optical axis 60 of the camera module 100 (focusing the camera module 100). It should be understood that distance traveled by the lens barrel 120 increases proportionally with the temperature of the SMAF 144. Therefore, angle degree focusing the camera module 100 is aligned in response to the movement of the lens barrel 120. Conversely, when the controller 150 stops applying the electric current to the SMAF 144, the temperature of the SMAF 144 may drop rapidly to below the martensite transition temperature, such that the SMAF 144 resumes its original shape and the internal stress on the SMAF 144 vanishes. The substrate 143 is restored, and the lens barrel 120 returns to its original position.

The SMAF 144 can be formed by: sputtering an amorphous titanium (Ti)-based, copper (Cu)-based, or ferrum (Fe)-based alloy film; and heating the amorphous alloy film to obtain excellent memory characteristics. In this embodiment, the shape-memory alloy film 144 may be a Ti-based alloy film, a Cu-based alloy film, or a Fe-based alloy film. Concretely, the Ti-based alloy film may be a titanium-nickel (TiNi), titanium-nickel-aluminium (TiNiAl), titanium-nickel-aluminium-zinc (TiNiAlZn), or titanium-nickel-aluminium-zinc-copper (TiNiAlZnCu) alloy film. The Cu-based alloy film may be a copper-zinc-aluminium (CuZnAl), copper-zinc-calcium (CuZnCa), copper-aluminium-nickel (CuAlNi), copper-aluminium-beryllium (CuAlBe), copper-zinc-silicon (CuZnSi), copper-aluminium-tellurium (CuAlTe), or copper-strontium-zinc alloy film (CuSrZn). The Fe-based alloy film may be a ferrum-platinum (FePt), ferrum-palladium (FePd), ferrum-chromium-nickel (FeCrNi), ferrum-nickel-carbon (FeNiC), ferrum-manganese (FeMn), ferrum-nickel-cobalt-titanium (FeNiCoTi), ferrum-manganese-silicon (FeMnSi) or ferrum-chromium-nickel-manganese-silicon (FeCrNiMnSi) alloy film.

The substrate 143 may be made from elastic material which can be bent by the SMAF 144. In addition, when the temperature of the SMAF 144 is lower than the martensite transition temperature, the internal stress of the SMAF 144 vanishes and the substrate 143 can recover its originally straight state rapidly. The substrate 143 may be a monocrystalline silicon film, a polycrystalline silicon film (e.x. SiO₂), or a polyester film.

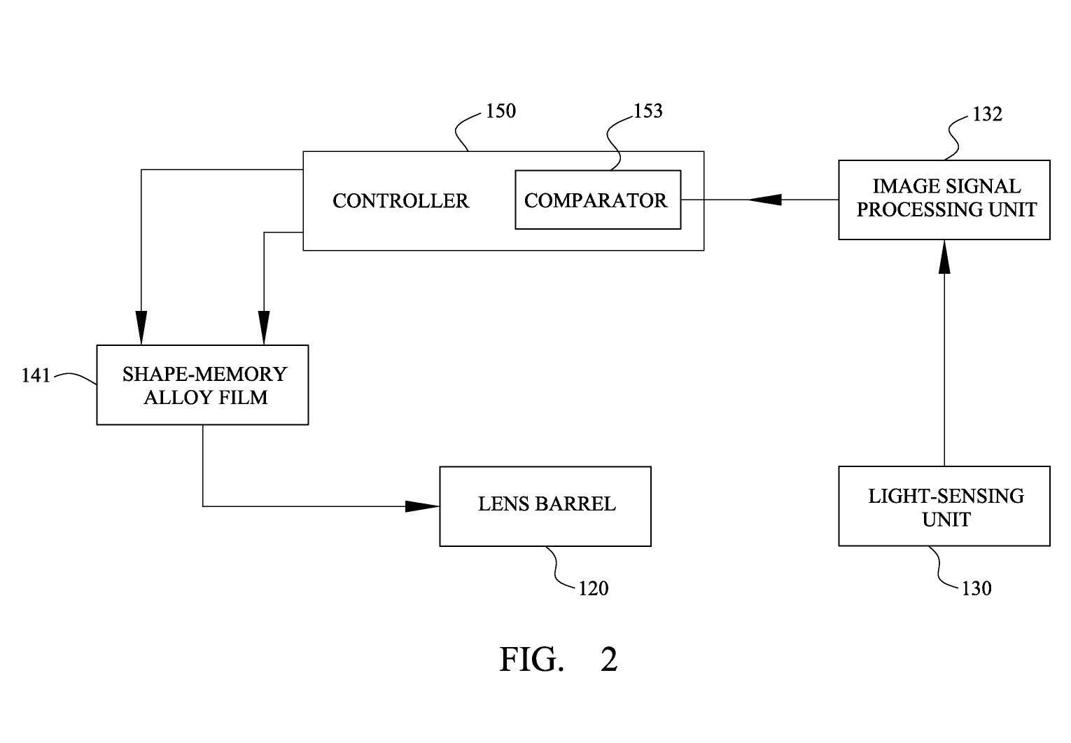

The controller 150 also has a comparator 153 (see FIG. 2). The comparator 153 is configured for comparing images sent from the ISP unit 132 when the SMAF 144 is heated and when it is not heated and selecting the best of the two.

The camera module 100 also includes two elastic sheets 142 embedded in the inner wall of the lens holder 110 and attached to the bottom surface of the lens barrel 120. The two elastic sheets 142 are substantially perpendicular to the optical axis 60 of the camera module 100. When the internal stress of SMAF 144 is relieved, the elastic sheet 142 speeds restoration of the lens barrel 120 to its former position. In this embodiment, the elastic sheet 142 is an elastic plate.

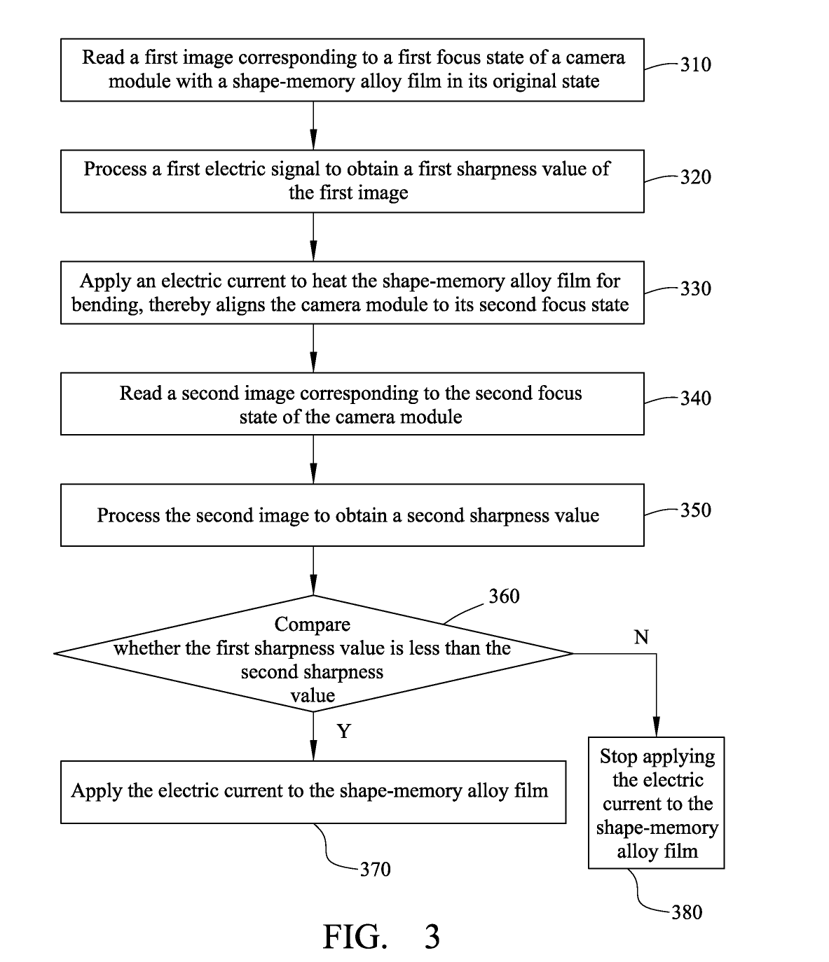

Referring to FIGS. 2 and 3, an autofocus method of the camera module 100 includes steps 310˜380.

In step 310, a first image corresponding to a first focus state of the camera module 100 with the SMAF 144 in its original state (straight and perpendicular to the optical axis 60 of the camera module 100) is read. In this embodiment, the light-sensing unit 130 receives and converts the first image into a first electric signal. In step 320, the first electric signal is processed to obtain a first sharpness value of the first image. In this embodiment, the ISP unit 132 processes the first image to acquire the first sharpness value and send the first sharpness value to the comparator 153. The first sharpness value can be characterized by parameters such as resolution value, contrast value, and modulation transfer function (MTF) known as spatial frequency response. In step 330, an electric current is applied to heat the SMAF 144, causing deformation thereof, thereby aligning the camera module 100 to its second focus state. In this embodiment, the SMAF 144 receives the electric current and is heated and flexibly bent, deforming the substrate 143 and moving the lens barrel 120 along the optical axis 60 of the camera module 100. In step 340, a second image corresponding to the second focus state of the camera module 100is read, and in step 350, the second image is processed to obtain a second sharpness value. In this embodiment, the second sharpness value is sent to the comparator 153.

In step 360, it is determined whether the first sharpness value is less than the second sharpness value, and, if so, step 370 is executed, and if not, the process proceeds step 380. In this embodiment, the first sharpness value and the second sharpness value are compared by the comparator 153. In step 370, electric current is applied to the SMAF 144. In this embodiment, the controller 150 provides the electric current to the SMAF 144 for bending, thus the camera module 100 remains in the second focus state. In step 380, electric current to the SMAF 144 is interrupted. In this embodiment, the SMAF 144 returns to its original state, and camera module 100 remains in the first focus state.

In the first exemplary embodiment, the SMAF 144 is employed in the camera module 100 for performing two-step focus through the heat of the actuator 141. Camera module 100 thus presents a miniaturized structure rapidly focusing by memory effect of the actuators 141.

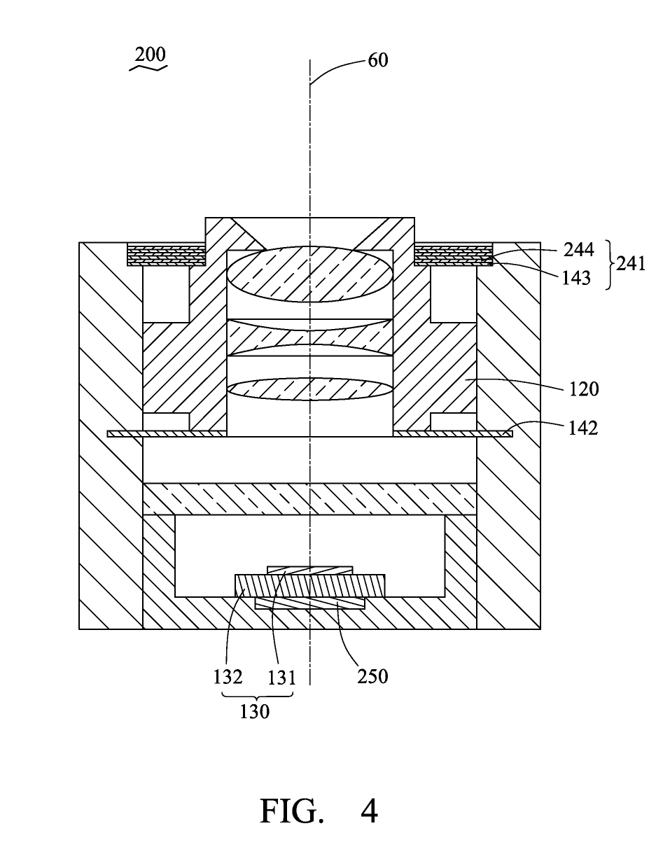

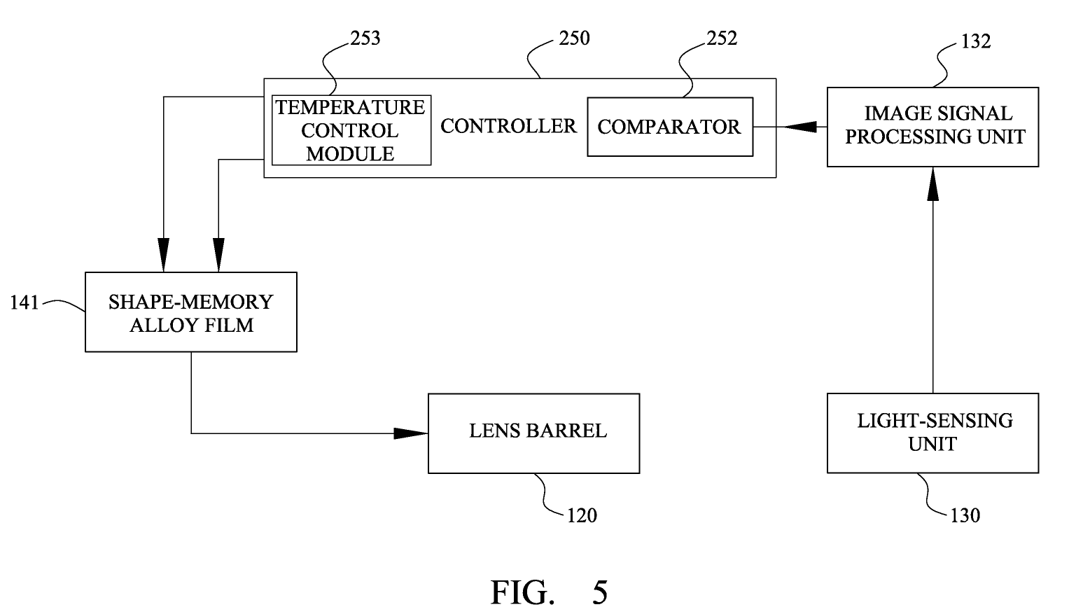

Referring to FIG. 4, a camera module 200 is shown, having an actuator 241 including N SMAFs 244 and the controller 250 has a temperature control module 253 (see in FIG. 5). In this embodiment, N represents a natural integer.

Concretely, the N SMAFs 244 are composed of different shape-memory alloy materials, or different quantities of the same constituent component of the shape-memory alloy materials. In both cases, the N SMAFs 244 have different transition temperatures from the martensite phase to the austensite phase, thus forming different bends.

Referring to FIG. 5, 6, an autofocus method of the camera module 200 includes the steps 610˜670.

In step 610, a first image corresponding to a first focus state of the camera module 200 is read with the SMAFs 244 in their original states (straight and perpendicular to the optical axis 60 of the camera module 200). In step 620, the first electric signal is processed to obtain a first sharpness value of the first image. In step 630, an electric current is applied to the SMAFs 244 to heat the SMAFs 244 for bending. In step 640, temperatures of the actuator 241 are changed, such that the SMAFs 244 can be controlled corresponding to requisite martensite transition temperatures. The actuator 141 receives the electric current for bending, thereby moving the lens barrel 120 along the optical axis 60 of the camera module 200. In this embodiment, the temperature control module 253 controls the temperatures of the N SMAFs 244 correspondingly. In step 650, N images corresponding to N focus states of the camera module 200 are read. In this embodiment, the light-sensing unit 130 receives the N images and converts them into N electric signals. In step 660, the N electric signals are processed to obtain N sharpness values of the N images which are then sent to the comparator 252. In step 670, it is determined whether the first sharpness value is less than one of the N sharpness values and the better sharpness value and corresponding temperature of the actuators, and if so, step 680 is executed and, if not, the process proceeds to step S690. In this embodiment, the temperature control module 253 controls the corresponding temperature of the actuator 241 such that the actuator 241 has its corresponding bend and the camera module 200 provides the best focus state for focusing.

In step 680, electric current is applied, controlling the corresponding temperature of the SMAFs 244, which, in this embodiment, bend, thus providing the better image. In step 690, the electric current to the SMAF 144 is terminated. In this embodiment, the SMAF 144 returns to its original state, thus providing the first image corresponding to the first sharpness value.

The second exemplary embodiment, the SMAFs 244 are employed in the camera module 200 for performing multi-step focus through the heat of the actuator 241. Therefore, the camera module 200 can have a miniaturized structure for rapidly focusing by a memory effect of the actuator 241.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A camera module, comprising:
a lens holder;
a lens barrel comprising a plurality of optical elements received therein and coupled to the lens holder;
a light-sensing element accommodated in the lens holder, optically aligned with the optical elements of the lens barrel;
an actuator comprising a shape-memory alloy film with two distal ends thereof attached to part of the lens holder and the lens barrel; and
a controller applying an electric current to deform the shape-memory alloy film to move the lens barrel along an optical axis of the camera module.

2. The camera module as claimed in claim 1, wherein the shape-memory alloy film is titanium-based, copper-based, or ferrum-based alloy film.

3. The camera module as claimed in claim 2, wherein the titanium-based alloy film is a titanium-nickel, titanium-nickel-aluminium, titanium-nickel-aluminium-zinc, or titanium-nickel-aluminium-zinc-copper alloy film.

4. The camera module as claimed in claim 2, wherein the copper-based alloy film is a copper-zinc-aluminium, copper-zinc-calcium, copper-aluminium-nickel, copper-aluminium-beryllium, copper-zinc-silicon, copper-aluminium-tellurium, or copper-strontium-zinc alloy film.

5. The camera module as claimed in claim 2, wherein the ferrum-based alloy film is a ferrum-platinum, ferrum-palladium, ferrum-chromium-nickel, ferrum-nickel-carbon, ferrum-manganese, ferrum-nickel-cobalt-titanium, ferrum-manganese-silicon or ferrum-chromium-nickel-manganese-silicon alloy film.

6. The camera module as claimed in claim 1, wherein the shape-memory alloy film is a multilayer film comprising a plurality of layers.

7. The camera module as claimed in claim 6, wherein each of the layers is a titanium-based, copper-based, or ferrum-based alloy film.

8. The camera module as claimed in claim 1, further comprising an elastic sheet comprising two distal ends attached to the lens holder and the lens barrel corresponding to the actuator.

9. An autofocus method of a camera module, the camera module comprising an actuator comprising at least one shape-memory alloy film, the method comprising:
reading a first image;
processing the first image to obtain a first sharpness value;
applying an electric current to heat the actuator of the camera module;
reading N images, N being more than or equal to 1;
processing N electric signals converted from the N images to obtain N sharpness values;
determining whether the first sharpness value is less than one of the N sharpness values; and
if so, applying the electric current to the actuator for focusing the camera module.

10. The autofocus method as claimed in claim 9, wherein the electric current to the actuator is interrupted if the first sharpness value is not less than one of the N sharpness values.

11. The autofocus method as claimed in claim 9, wherein the first sharpness value and the N sharpness values are received by a light-sensing unit of the camera module.

12. The autofocus method as claimed in claim 9, determination of whether the first sharpness value is less than one of the N sharpness values is performed by a comparator of the camera module.

13. The autofocus method as claimed in claim 9, wherein the electric current is applied to the actuator for moving a lens barrel of the camera module along an optical axis of the camera module.

14. The autofocus method as claimed in claim 9, wherein the actuator has N shape-memory alloy films if N is over 1.

15. The autofocus method as claimed in claim 14, wherein temperatures of the N shape-memory alloy films corresponding to different martensite transition temperatures are controlled before the N image is read.

16. The autofocus method as claimed in claim 15, wherein the temperatures of the N shape-memory alloy films are controlled corresponding to different martensite transition temperatures by a temperature control module.

17. The autofocus method as claimed in claim 9, wherein the shape-memory alloy film is titanium-based, copper-based, or ferrum-based alloy film.

18. The autofocus method as claimed in claim 9, wherein the first sharpness value and one of the N sharpness value can be characterized by modulation transfer function known as spatial frequency response.
